(19) United States
(12) Patent Application Publication
(10) Pub. No.: US 2016/0362621 A1
(43) Pub. Date: Dec. 15, 2016

(54) SYSTEM FOR PRODUCING SYNGAS USING PRESSURIZED OXYGEN

(71) Applicant: KASHONG LLC, Hollywood, CA (US)

(72) Inventor: Steven G. Goebel, Victor, NY (US)

(21) Appl. No.: 14/739,309

(22) Filed: Jun. 15, 2015

(51) Int. Cl. C10J 3/06; C10K 1/00; H01M 8/1246; F02C 3/20; H01M 8/0612; C10J 3/20; C10K 1/10

(52) U.S. Cl. CPC C10J 3/06; C10J 3/20; C10K 1/008; C10K 1/007; C10K 1/101; F02C 3/20; H01M 8/0643; H01M 8/1246; C10J 2200/15; C10J 2300/0946; C10J 2300/0959; C10J 2300/12; C10J 2300/1671; C10J 2300/1884; C10J 2300/1869; H01M 2008/1293

(57) ABSTRACT

A system and method of producing syngas from a solid waste stream is provided. The system includes a low tar gasification generator that gasifies the solid waste stream to produce a first gas stream. A process module cools the first gas stream and removes contaminants, such as metals, sulfur and carbon dioxide from the first gas stream to produce a second gas stream having hydrogen. The second gas stream may be received by a power module that generates electrical power from the second gas stream. The process module may include one or more heat exchangers. The process module may further increase the pressure of an oxygen gas stream that flows to the gasification generator.

### BACKGROUND OF THE DISCLOSURE

The subject matter disclosed herein relates to a system for converting solid waste, such as municipal waste and conversion into syngas.

Traditionally, municipal solid waste was disposed of by dumping of the waste into the ocean, burning in incinerators or burying in landfills. Due to the undesired environmental effects (e.g. release of methane into the atmosphere and contamination of ground water) of these practices, many jurisdictions have prohibited their expansion or implementation. In some parts of the world, gasification technologies have been used to eliminate municipal waste.

Gasification is a process that decomposes a solid material to generate a synthetic gas, sometime colloquially referred to as syngas. This syngas typically includes carbon monoxide, hydrogen and carbon dioxide. The produced syngas may then be burned to generate steam that drives large gas turbines (50 MW) to generate electricity. There are several technologies of that are used, including an up-draft gasifier, a down-draft gasifier, a fluidized bed reactor, an entrained flow gasifier and a plasma gasifier. All gasifiers utilize controlled amounts of oxygen to decompose the waste. One issue with current systems is that the use of a gas turbine requires large amounts of waste and correspondingly large amounts of amounts of oxygen. As a result, these gasifiers have to be located close to areas where both the waste fuel and oxygen may be readily supplied in large volumes. Further, since steam is generated in the process, to maintain efficiencies the systems need to be located in major industrial complexes where the steam can be used in process or district heating systems.

Accordingly, while existing gasification systems have been suitable for their intended purposes the need for improvement remains, particularly in providing a system that can operate at higher efficiency.

### BRIEF DESCRIPTION OF THE DISCLOSURE

According to one aspect of the disclosure a system for converting solid waste material to syngas is provided. The system including an input module having a low tar gasification generator configured to produce a first gas stream in response to an input stream of solid waste material, the first gas stream including hydrogen. The input module includes an input port. A process module is fluidly coupled to receive the first gas stream, the process module including a first heat exchanger operable to transfer thermal energy to an oxygen gas stream and is fluidly coupled to transfer the oxygen stream to the input port. The process module further including at least one clean-up process module fluidly coupled to the first heat exchanger to receive the cooled first gas stream. The at least one clean-up process module is configured to remove at least one contaminant from the first gas stream and produce a second gas stream containing hydrogen. A hydrogen conversion device is configured to receive the second gas stream and generate electrical power based at least in part from the hydrogen in the second gas stream.

According to another aspect of the disclosure a method of producing electrical power from a solid waste stream is provided. The method comprising the steps of: receiving the solid waste stream at a gasification generator; receiving an oxygen gas stream at the gasification generator; producing a first gas stream and residual materials with the gasification generator; transferring the first gas stream to a first heat exchanger; decreasing the temperature of the first gas stream with the first heat exchanger; flowing a heat transfer medium from the first heat exchanger to the gasification generator; performing at least one clean-up process on the first gas stream to remove at least on contaminant; generating a second gas stream with the at least one clean-up process, the second gas stream including hydrogen; receiving the second gas stream with a hydrogen conversion device; and generating electrical power with the hydrogen conversion device based at least in part on receiving the second gas stream.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a schematic diagram of the system for generating electrical power through the gasification of solid waste in accordance with an embodiment of the invention;

FIG. 2 is a schematic diagram of a gasifier module for use with the system of FIG. 1;

FIG. 3 is a schematic diagram of a process module for use with the system of FIG. 1 in accordance with an embodiment of the invention;

FIG. 4 is a schematic diagram of a process module for use with the system of FIG. 1 in accordance with another embodiment of the invention; and

FIG. 5 is a schematic diagram of a power generation module for use with the system of FIG. 1.

The detailed description explains embodiments of the disclosure, together with advantages and features, by way of example with reference to the drawings.

### DETAILED DESCRIPTION OF THE DISCLOSURE

Embodiments of the invention provide advantages in the high efficiency generation of electrical power from solid waste, such as municipal waste. Embodiments of the invention provide advantages in the generation of electrical power with high efficiency using low tar gasification systems that supply hydrogen enhanced syngas suitable for use with a solid oxide fuel cell. Still further embodiments of the invention provide advantages in the processing of municipal waste at lower electrical power outputs and lower oxygen consumption such that it is suitable for operation at a landfill.

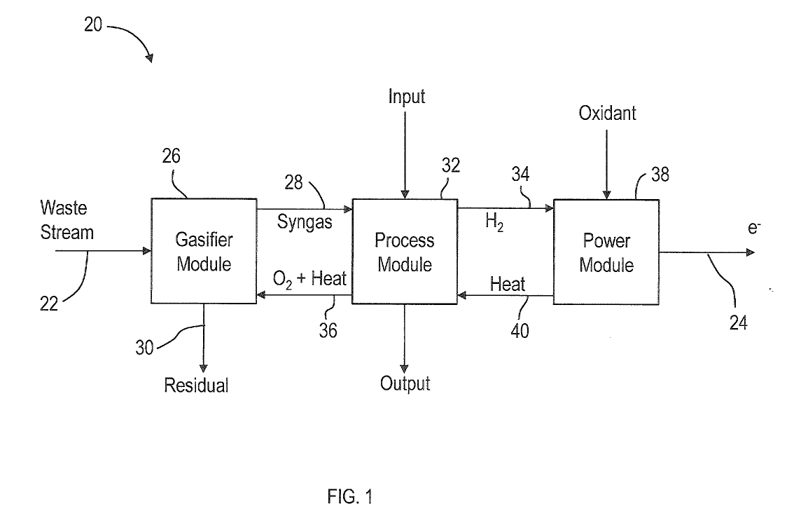

Referring now to FIG. 1, an exemplary system 20 is illustrated for converting a solid waste input stream 22 into generated electrical power 24. The system 20 includes a gasification module 26 that receives the solid waste stream 22 and outputs a syngas 28 and a residual stream 30. The residual stream 30 may include slag (e.g. a mixture of metal oxides and silicon dioxide) and recovered metals. In one embodiment, the residual stream is recovered and recycled into the manufacture of other products, such as concrete for example. The syngas 28 is mainly comprised of hydrogen (H₂) and carbon monoxide (CO) when oxygen gas is used as an input for the gasification process. Where air is used as an input, the syngas 28 may further include nitrogen or nitrogen compounds.

The syngas 28 is transferred from the gasifier module 26 to a process module 32. As will be discussed in more detail herein, the process module 32 modifies the syngas stream 28 to provide an output fuel stream 34 having an enhanced hydrogen content. To accomplish this, the process module 32 provides several functions, including the quenching of the syngas to reduce or avoid the formation of undesirable compounds (e.g. dioxins and furans), the removal of particulates and solids from the gas stream, and the removal of impurities or contaminants such as sulfur, nitrogen and carbon dioxide. The process module 32 further conditions the output fuel stream 34 to have the desired pressure, temperature and humidity so that it is suitable for downstream use.

The process module 32 may include a number of inputs, such as but not limited to water, oxygen and solvents such as amine based solvents (e.g. Monoethanolamine). The oxygen input may be used to absorb thermal energy from the syngas 28. Thus, the oxygen stream 36 has an elevated temperature (200 C) when it is transferred to the gasifier module 26. Since the oxygen temperature is increased, the efficiency of the gasification is increased as well. In one embodiment, a steam loop may be used as a heat transfer medium between the syngas and oxygen. Still further advantages may be gained where the thermal energy from said steam loop heated by the syngas stream 28 is used to heat the solid waste stream 22 to reduce the moisture content and improve the quality of the solid waste as a fuel for the gasification process.

The process module 32 further conditions the output fuel stream 34 to have the desired temperature so that it is suitable for downstream use. In one embodiment, the syngas stream 28 exits the gasifier module at a temperature of 700-1000 C. The absorption of thermal energy from the syngas 28 by the oxygen gas stream (through a steam loop) allows the process module to condition the syngas stream for use with clean-up processes that operate at lower temperatures. In some embodiments, these clean-up processes operate at temperatures in the range of 50-450 C. However, as is discussed in more detail herein, in an exemplary embodiment, the downstream process is a power module 38 having a solid oxide fuel cell (SOFC). Since SOFC systems operate at elevated temperatures, such as 700-850 C for example, excess heat 40 from the power module 38 may be transferred into the process module 32 to elevate the output fuel stream 34 to the desired temperature.

It should be appreciated that the synergistic use and transfer of thermal energy and heat transfer mediums between the modules 26, 32, 38 provides advantages in increasing the efficiency and improving the performance of the system 20.

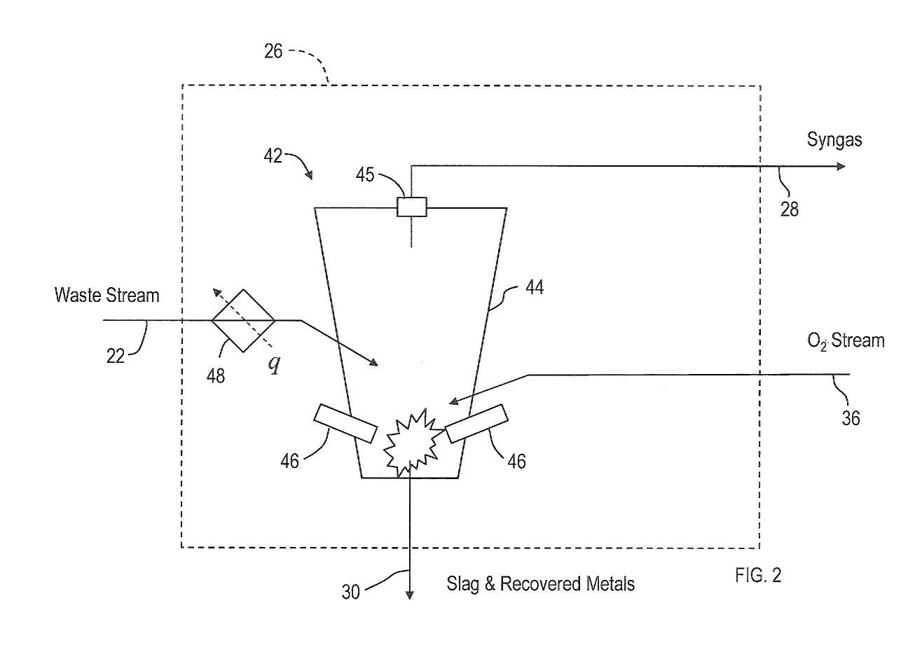

Turning now to FIG. 2, an exemplary gasifier module 26 is shown for converting solid waste 22 into a syngas stream 28. It should be appreciated that the solid waste stream 22 is not limited to municipal waste, but may include other types of solid waste such as but not limited to hazardous waste, electronic waste, bio-waste, coke and tires for example. In one embodiment, the gasifier module 26 includes a plasma gasifier 42 that is configured to receive the waste stream 22, the oxygen stream 36 and output the syngas stream 28 and residual stream 30. It should be appreciated that while embodiments herein describe the gasifier module 26 as including a plasma gasifier, this is for exemplary purposes and the claimed invention should not be so limited. In other embodiments, other gasifier technologies that are capable of producing syngas at high temperatures (>1000 C) with low tar may be used. In one embodiment, the gasifier produces a syngas with a tar level of less than or equal to 0.5 mole % and preferably between 0.1-0.5 mole %.

In one embodiment, the plasma gasifier 42 includes an inverted frusto-conical shaped housing 44. A plurality of plasma torches 46 are arranged near the bottom end of the housing 44. The plasma torches 46 receive a high-voltage current that creates a high temperature arc at a temperature of about 5,000 C. It should be appreciated that while FIG. 2 illustrates a single point of entry for the waste stream 22, the oxygen stream 36 and a pair of plasma torches, this is for exemplary purposes and the claimed invention should not be so limited. In some embodiments there is a plurality of input ports for the streams 22, 36 disposed about the circumference of the housing 44.

A plasma arc gasifier breaks the solid waste into elements such as hydrogen and simple compounds such as carbon monoxide by heating the solid waste to very high temperatures with the plasma torches 46 in an oxygen deprived environment. The gasified elements and compounds flow up through the housing 44 to an output port 45 that fluidly couples the housing 44 to the process module 32. The syngas stream 28 exits the gasifier module 26 at a temperature of about 1000 C. The residual materials 30, typically inorganic materials such as metals and glasses melt due to the temperature of the plasma and flow out of the housing 44 and are recovered.

In one embodiment, the gasifier module 26 may include a heat transfer element 48 that transfers a portion of the thermal energy “q” from the heat transfer medium to the waste stream 22 prior to the waste stream 22 entering the plasma gasifier 42. The heat transfer element 48 may be coupled to receive the heat transfer medium from one or more points within the system 20. It should be appreciated that solid waste, such as municipal waste, may have a high moisture content and it may be desirable to lower this moisture content prior to gasification to improve efficiency. Thus the thermal energy q may be used to dry the solid waste stream 22. In one embodiment, the transfer of thermal energy may be selectively applied to the waste stream 22, such as in response to changing conditions in the solid waste for example.

It has further been found that plasma gasifiers provide advantages over other gasifier technologies since they generate very little tar (mixture of hydrocarbons and free carbon) due to the high temperatures used in operation.

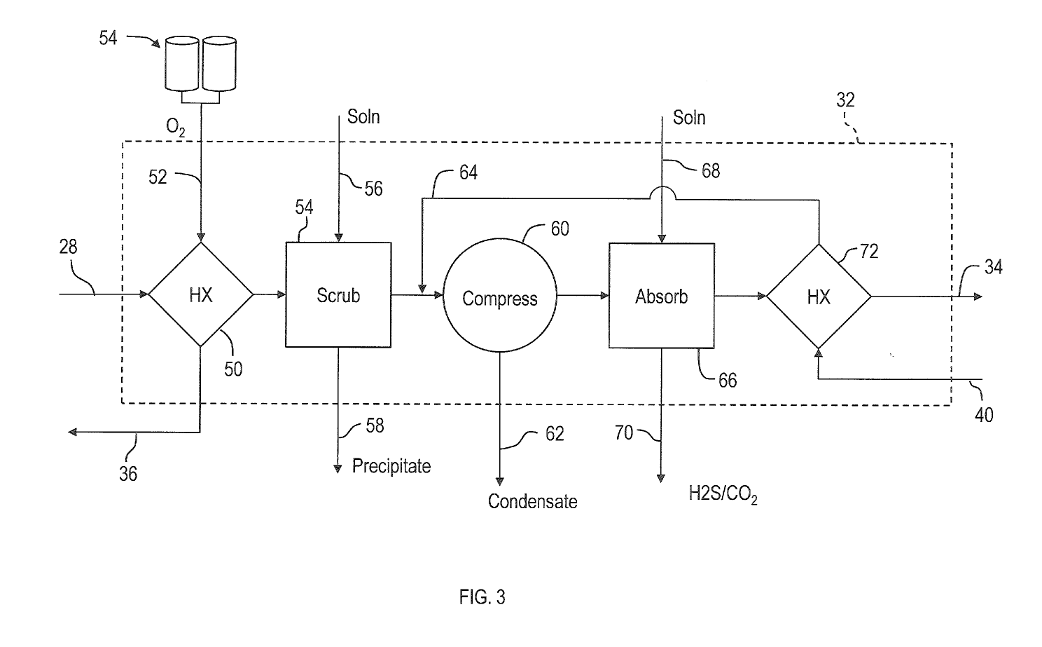

Referring now to FIG. 3 an embodiment is shown of the process module 32. The syngas stream 28 is first received by a heat exchanger 50 that reduces the input temperature from about 1000 C to about 150 C. The process module 32 may include an initial quench water spray that reduces the initial input temperature from 1000 C to 850 C. The heat exchanger 50 receives an oxygen gas stream 52 and may also receive water for initial quenching and to be used as a heat transfer medium. In one embodiment the oxygen gas stream 52 is received from a liquid oxygen storage unit 54. The oxygen storage unit 54 may include at least two storage units to allow continuous operation of the system 20 when one of the storage units is empty and being replenished.

The oxygen gas stream 52 absorbs thermal energy from the syngas stream 28 as it passes through the heat exchanger 50. In one embodiment, the heated oxygen stream 36 has a temperature of 200 C at a pressure of 10 atm (about 147 psi or 1 megapascal). It should be appreciated that heating the oxygen to the boiling phase change allows for an increase in pressure without the use of a compressor. Providing the oxygen stream 36 with an elevated pressure level provides advantages in increasing the pressure level of the syngas stream 28. As will be discussed in more detail below, a pressurized syngas stream 28 provides further advantages in allowing certain cleaning processes to operate without the use of secondary compression. It should be appreciated that mechanical compression of the syngas would be a parasitic load on the system 20 that would reduce the overall efficiency. In the exemplary embodiment, the system is configured to provide the oxygen gas stream 52 at a pressure sufficient to provide a syngas stream 28 at the output of the gasification module 26 at a pressure greater than about 140 psi (0.95 megapascal).

The cooled syngas stream 28 flows from the heat exchanger 50 to a first clean-up process module 54. In one embodiment, the first clean-up process module 54 is a scrubber that receives a solvent (typically water) input 56 and precipitates particulates, such as metals (including heavy metals) and dissolves halides and alkali from the syngas stream 28. The first clean-up process module 54 may further remove chlorine from the syngas stream 28. The precipitate stream 58 is captured and removed from the system 20.

In one embodiment, once the particulates and some contaminants are removed, the syngas stream 28 flows to an optional compressor 60 that elevates the pressure of the syngas for further processing. In a system with pressurization achieved by boiling of the liquid oxygen supply, the compressor only needs to drive a recirculation flow through the process and power generation modules. The compressor 60 increases the pressure of the syngas stream 28 to 147 psi (1 megapascals). The compressor 60 may include intercoolers that cause water within the syngas stream to condense out of the gas. This condensate is captured and removed from the system via a condensate trap 62. It should be appreciated that since the syngas stream 28 enters the process module 32 at an elevated pressure due to the pressurization performed (and the energy used) by the compressor 60 is considerably less than a system where the syngas stream 28 starts at a lower or ambient pressure. It should be appreciated that for a system without a pressurized gas supply, about 22% of the gross electric output would be required to drive a compressor to elevate the syngas pressure from 1 to 10 atm.

In one embodiment, a secondary gas stream 64 is injected into the syngas stream 28 before compression. As will be discussed in more detail below, this secondary gas stream 64 may be received from the anode side of a SOFC. In other words, the secondary gas stream 64 consists of syngas that was not converted by, and subsequently exits, the SOFC and is recycled back into the process module 32. Typically, an SOFC only utilizes about 50% of the incoming fuel. It should be appreciated that advantages are gained by flowing the secondary gas stream 64 prior to compression as the compressor 60 will remove water product from the secondary gas stream and the absorber 66 will remove the CO2 to reduce accumulation of these and other contaminants. Thus only a small amount of nitrogen will accumulate in the system, which may be periodically purged or bled as is known in the art.

Once the syngas stream 28 has been compressed, the stream enters a second clean-up process module 66. In one embodiment, the second clean-up process module 66 is an amine based absorber that uses an input solvent 68 such as monoethanolamine (MEA) that absorbs and removes contaminants such as carbon dioxide and sulfur (typically as H2S) from the gas stream. These contaminants are captured and removed via a contaminant stream 70.

In the exemplary embodiment, the power module 38 includes a SOFC. These fuel cells operate at elevated temperatures in the range of 700-1000 C. Since the sub-processes of the process module 32 operate at lower temperatures (50-150 C), a heat exchanger 72 receives the cleaned syngas steam and increases the temperature to a desired temperature, such as above 700 C for example. In the exemplary embodiment, the heat transfer medium 40 is the secondary gas stream 64 received from the SOFC. Thus the heat exchanger 72 provides advantages in both increasing the temperature of the syngas stream from the process module 66 to the desired operating temperature and reducing the temperature of the secondary gas stream 64 to a temperature compatible with the sub-processes of the process module 32. In one embodiment, the secondary gas stream enters the heat exchanger 72 at 850 C and exits at 150 C.

With the temperature of the syngas increased to the desired temperature, the output fuel stream 34 exits the process module 32. It should be appreciated that the process module 32 may include additional processing modules to condition the output fuel stream 34, such as humidifiers for example.

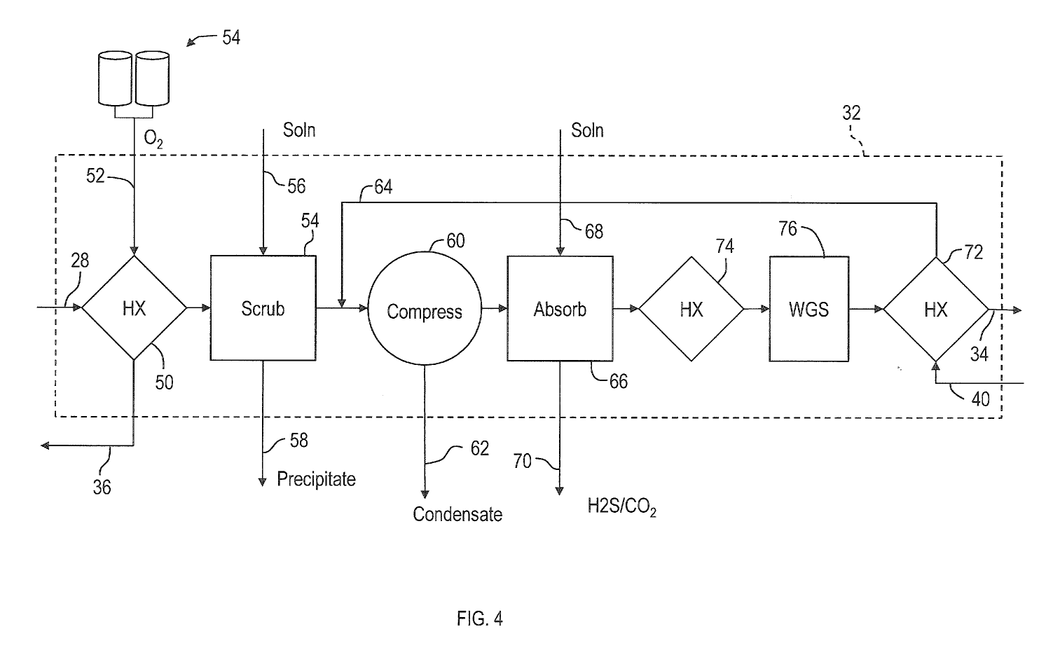

Turning now to FIG. 4, another embodiment is shown of a process module 32. This embodiment is similar to the embodiment of FIG. 3 with an added sub-process module to further enhance the hydrogen content of the syngas stream through the reduction of carbon monoxide. In this embodiment, the syngas stream 28 exits the absorber process module 66 and enters heat exchanger 74 that increases the temperature of the syngas to 250-350 C

With the temperature of the syngas stream 28 at the desired operating temperature, the syngas enters a water-gas shift module 76. In a water-gas shift reaction the syngas is exposed to a catalyst, such as iron oxide-chromium oxide or a copper-based catalyst for example. The water-gas shift module 76 reduces the carbon monoxide content of the syngas stream to less than or equal to 10 percent by converting it with water vapor to additional hydrogen and carbon dioxide. In one embodiment, the water-gas-shift module 76 includes multiple-stages that operate in the 150-450 C temperature range. Each of these stages may be exothermic and additional heat exchangers may be used to remove thermal energy between each stage. It should be appreciated that different catalysts may be used in different stages of the water-gas shift module 76. The extracted thermal energy may be either transferred to the environment or in some embodiments transferred to other portions of the system 20, such as the heat exchanger 72 or for drying the solid waste stream 22 for example. In one embodiment, the thermal energy is used to drive one or more small gas turbines.

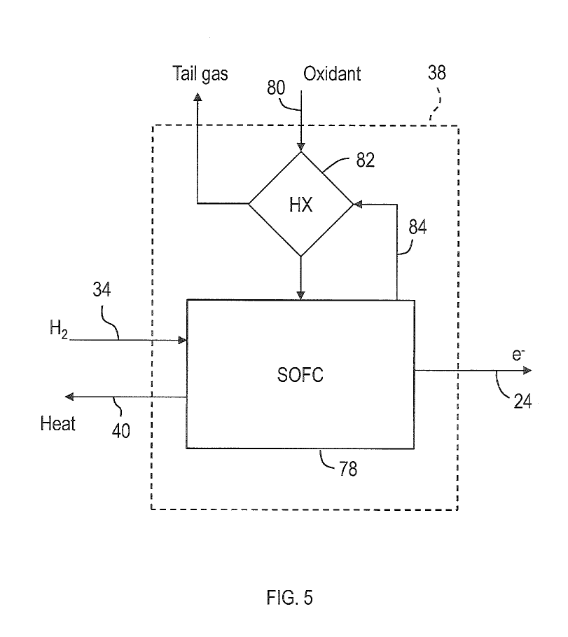

Referring now to FIG. 5, an exemplary power module 38 is shown having a SOFC 78. It should be appreciated that while embodiments herein describe the power module 38 as having a SOFC, this is for exemplary purposes and the claimed invention should not be so limited. In other embodiments, the module 38 may be used to drive other electrical generation systems, such as a steam generator that cooperates with a gas turbine or by directly converting the syngas by combustion in an internal combustion engine drive generator for example. In still other embodiments, the module 38 includes a Fischer-Tropsch process sub-module.

The output gas stream 34 enters the power module 38 and is received by the SOFC 78. A SOFC is an electrochemical conversion device that generates electrical power by the direct oxidation of a hydrogen based fuel. The SOFC uses a solid oxide material as an electrolyte to conduct oxygen ions from a cathode to an anode. The SOFC operates at very high temperatures, typically 700-1000 C. Thus, the system 20 provides advantages in that the output gas stream 34 may be delivered from the process module 32 at or nearly at the operating temperature of the SOFC.

To produce electrical power 24, the SOFC 78 receives an oxidant, such as air as an input 80 that passes through a heat exchanger 82 where the temperature of the oxidant is increased. The heat exchanger 82 is fluidly coupled to receive cathode tail gas 84 that has been heated by the operation of the SOFC 78. The tail gas 84 passes through the heat exchanger 82 and then exits the system.

It should be appreciated that not all of the hydrogen and CO in the output gas stream 34 may be consumed during operation. During operation, the output gas stream 34 enters the anode side of the SOFC 78 where, in the presence of an anode catalyst, some of the hydrogen combines with the oxygen ions that migrated through the electrolyte. This exchange releases electrons and produces water. Water gas shift reactions also occur within the anode transforming CO and water vapor to CO2 and hydrogen. The water, CO2 and any unused fuel from the output gas stream exits the anode. This excess fuel stream 40 exits at or nearly at the operating temperature of the SOFC 78. As discussed herein, this fuel stream passes through the heat exchanger 72 to preheat the output gas stream 34 and is subsequently recycled back into the process as the secondary gas stream 64.

It should be appreciated that embodiments of the invention provide advantages in allowing the gasification of solid waste to produce electrical power. Embodiments of the invention allow for the increase in efficiency of the system by utilization of the thermal energy generated during operation that would normally be dissipated in the ambient environment to enhance operation, such as by drying the solid waste stream or conditioning the input fuel stream to a solid oxide fuel cell. Still further embodiments of the invention provide advantages in increasing the pressure of the oxygen entering a gasifier using heat from the gasifier output stream. This pressurized oxygen provides a desired pressure increase in the gasifier output stream that reduces or eliminates the use of downstream compressors to further increase the efficiency of the system.

The term “about” is intended to include the degree of error associated with measurement of the particular quantity based upon the equipment available at the time of filing the application. For example, “about” can include a range of ±5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A system for converting solid waste material to syngas comprising:
an input module having a low tar gasification generator configured to produce a first gas stream in response to an input stream of solid waste material, the first gas stream including hydrogen, the input module including an input port; and
a process module fluidly coupled to receive the first gas stream, the process module including a first heat exchanger operable to transfer thermal energy from the first gas stream to an oxygen gas stream, the first heat exchanger being fluidly coupled to transfer the oxygen gas stream to the input port, the process module further including at least one clean-up process module fluidly coupled to the first heat exchanger to receive the cooled first gas stream, the at least one clean-up process module configured to remove at least one contaminant from the first gas stream and produce a second gas stream containing hydrogen.

2. The system of claim 1 wherein the first heat exchanger is further configured to receive the oxygen gas stream at a first temperature and first pressure, the first heat exchanger further being configured to transfer thermal energy to the oxygen gas stream, wherein the oxygen gas stream exits the first heat exchanger at a second temperature and second pressure, the second temperature being greater than the first temperature.

3. The system of claim 2 wherein the second temperature is about 200 C and the second pressure is about 1 megapascal.

4. The system of claim 3 wherein the first gas stream exits the input module at a third pressure, the third pressure being above ambient pressure.

5. The system of claim 4 wherein the third pressure is greater than or equal to 0.95 megapascal.

6. The system of claim 5 wherein the at least one clean-up process module operates at the third pressure.

7. The system of claim 1 wherein the at least one clean-up process module includes a first clean-up process module and a second clean-up process module, the first clean-up process module being fluidly coupled to receive the first gas stream from the first heat exchanger, the second clean-up process module being fluidly coupled to receive the first gas stream from the first clean-up process module and produce the second gas stream.

8. The system of claim 1 further comprising a hydrogen conversion device configured to receive the second gas stream and generate electrical power based at least in part from the hydrogen in the second gas stream.

9. The system of claim 8 wherein the hydrogen conversion device is a solid oxide fuel cell.

10. The system of claim 8 wherein the hydrogen conversion device is a Fischer Tropsch process.

11. A method of producing electrical power from a solid waste stream comprising:
receiving the solid waste stream at a gasification generator;
receiving an oxygen gas stream at the gasification generator;
producing a first gas stream and residual materials with the gasification generator;
transferring the first gas stream to a first heat exchanger;
decreasing the temperature of the first gas stream with the first heat exchanger;
flowing a heat transfer medium from the first heat exchanger to the gasification generator;
performing at least one clean-up process on the first gas stream to remove at least on contaminant; and
generating a second gas stream with the at least one clean-up process, the second gas stream including hydrogen.

12. The method of claim 11 further comprising:
receiving the second gas stream with a hydrogen conversion device; and
generating electrical power with the hydrogen conversion device based at least in part on receiving the second gas stream.

13. The method of claim 11 wherein the heat transfer medium is an oxygen gas stream.

14. The method of claim 13 further comprising:
flowing the oxygen gas stream through the first heat exchanger prior to receiving the oxygen gas stream at the gasification generator; and
increasing a temperature and first pressure of the oxygen gas stream at the first heat exchanger.

15. The method of claim 14 wherein the first gas stream has a second pressure, the second pressure based at least in part on the first pressure of the oxygen gas stream.

16. The method of claim 15 wherein the first pressure is about 1 megapascal and the second pressure is great than or equal to about 0.95 megapascal.

17. The method of claim 14 wherein at least one clean-up process comprises:
a first clean-up process that precipitates particulates and dissolve chemicals from the first gas stream; and
a second clean-up process that removed sulfur and carbon dioxide from the first gas stream.

18. The method of claim 17 wherein the at least one clean-up process further includes a water-gas shift process that converts carbon monoxide and water vapor to hydrogen and carbon dioxide.

19. The method of claim 17 further comprising transferring thermal energy in a second heat exchanger to the second gas stream prior to receiving the second gas stream at the hydrogen conversion device.

20. The method of claim 12 wherein the hydrogen conversion device is a solid oxide fuel cell.

21. The method of claim 12 wherein the hydrogen conversion device is a Fischer Tropsch process.
